(19) United States
(12) Patent Application Publication
(10) Pub. No.: US 2013/0298367 A1
(43) Pub. Date: Nov. 14, 2013

(54) Fitting Assembly for Use in a Pool Wall

(71) Applicant: Leonard P. Verdenik, Winnipeg (CA)

(72) Inventor: Leonard P. Verdenik, Winnipeg (CA)

(21) Appl. No.: 13/946,324

(22) Filed: Jul. 19, 2013

Related U.S. Application Data
(62) Division of application No. 12/814,765, filed on Jun. 14, 2010.
(60) Provisional application No. 61/187,715, filed on Jun. 17, 2009.

(51) Int. Cl. E04H 4/12; F16L 5/08

(52) U.S. Cl. CPC E04H 4/12; F16L 5/08
USPC 29/402.08

(57) ABSTRACT

A pool wall fitting assembly includes a tubular member extending through an opening in the pool wall. An inner flange member is threaded onto the inner end of the tubular member and includes a flange portion arranged to overlap the inner surface of the pool wall about a periphery of the opening. A retainer is arranged to be selectively fixed relative to the tubular member with an anchor member supported between the retainer and the outer surface of the pool wall. A clamping mechanism operable between the anchor member and the outer surface of the pool wall so as to be arranged to urge the anchor member and retainer fixed on the tubular member away from the outer surface of the pool wall such that the pool wall is clamped between the inner flange member and the clamping mechanism.

This application is a divisional of U.S. patent application Ser. No. 12/814,765, filed Jun. 14, 2010 and claims the benefit under 35 U.S.C.119(e) of U.S. provisional application Ser. No. 61/187,715, filed Jun. 17, 2009.

### FIELD OF THE INVENTION

The present invention relates to a fitting assembly for communicating a pool inlet or outlet through a pool wall, and more particularly the present invention relates to a fitting assembly which is suited for replacing an exiting fitting assembly in the pool wall.

### BACKGROUND

In a typical pool construction, a concrete wall surrounds the pool area and supports a vinyl lining member across an inner surface thereof. Water from the pool is typically circulated from drain fittings in the pool to a filter housing which then returns the filtered water to the pool through various inlet fittings. Each of the fittings is typically located to communicate through the concrete wall surrounding the pool by providing a pipe which extends through a corresponding opening in the wall for communication between an inner flange member at the inner surface of the pool wall and an outer end at the outer surface of the wall which communicates back to the filter housing. In an initial pool construction, it is common for the fittings and the pipe to be cast into the wall to provide a suitable seal at the inner end relative to the pool wall. Replacing a fitting however typically requires boring a larger opening through the wall to remove the cast-in-place fittings prior to extending a new pipe through the resulting opening in the wall. To provide adequate structural support, the new fitting and pipe are typically required to be cast in place with new concrete however the subsequently cast concrete commonly does not provide an adequate securement within the bore and is awkward and time consuming to set.

U.S. Pat. No. 4, 561,134 by Matthews et al. discloses a fitting assembly for vinyl lined pools in which the construction of the inner flange is shown for clamping the vinyl layer between first and second flange portions. No means are provided for anchoring the fitting securely against the concrete wall about the bore surrounding the pipe extending through the wall. Such a flange design is therefore very difficult to adequately seal against the inner surface of the pool walls when not cast-in-place.

Various examples of fittings for being mounted in sealed configuration through an opening in a thin walled enclosure are described in U.S. Pat. Nos. 3,749,424 by Greene, 3,181,899 by McKnight Jr., 4,613,169 by Engelhart and 5,971,444 by Hawkins. In each instance however the fitting is relatively small in size such that an integral pipe portion of the fitting extends fully through the wall and so that a large threaded nut can be fastened about the pipe at the external side of the wall. The large nut required is particularly difficult to tighten in retro-fit applications where often there is limited access to the outer side of the pool wall. Furthermore the threaded connection of the large nut requires the outer end of the pipe protruding from the outer side of the wall to be threaded along the length thereof. In this manner the length of the pipe portion cannot be adjusted as cutting the threaded pipe will damage the external threads thereof such that the nut can no longer be readily fastened onto the pipe portion. Furthermore the pipe portion in this instance is not readily suited to subsequent connection to standard size piping.

U.S. Pat. No. 5,466,015 by Berenter discloses a further example of a device for mounting through a wall. In this instance the outer end of the pipe must also be externally threaded along the length thereof to accept a threaded member such as a nut about the full diameter of the pipe so as to be awkward to manipulate and so as to prevent cutting of the length at various desired locations as with the prior patents noted above. Furthermore the arrangement of the inner end of the pipe is large and cumbersome so as to be unsuitable for being mounted at the finished inner surface of a pool wall.

### SUMMARY OF THE INVENTION

According to one aspect of the invention there is provided a fitting assembly arranged for use in a pool wall comprising an inner surface, an outer surface and an opening extending through the wall from the inner surface to the outer surface of the pool wall, the fitting assembly comprising:

a tubular member extending in a longitudinal direction between an inner end and an outer end so as to be arranged to extend through the opening in the pool wall from the inner surface to the outer surface thereof;

the inner end of the tubular member being threaded;

an inner flange member comprising a central portion arranged for threaded connection to the inner end of the tubular member and a flange portion extending radially outward from the central portion so as to be arranged to overlap the inner surface of the pool wall about a periphery of the opening;

an anchor member arranged to be supported about the tubular member adjacent the outer end for sliding movement relative to the tubular member in the longitudinal direction;

a retainer arranged to be fixed relative to the tubular member adjacent the outer end of the anchor member so as to be arranged to restrict movement of the anchor member in the longitudinal direction relative to the tubular member towards the outer end of the anchor member;

a clamping mechanism operable between the anchor member and the outer surface of the pool wall so as to be arranged to urge the anchor member together with the outer end of the tubular member relative to which the anchor member is retained by the retainer away from the outer surface of the pool wall such that the pool wall is arranged to be clamped between the inner flange member and the clamping mechanism.

The fitting assembly may further comprise an outer flange member having a central portion arranged to be supported on the tubular member between the anchor member and the outer surface of the pool wall for sliding movement relative to the tubular member in the longitudinal direction and a flange portion extending radially outward from the central portion such that the clamping mechanism is arranged to be operable between the anchor member and the outer flange member when the outer flange member is abutted against the outer surface of the pool wall.

By providing an anchor member which is slidable along the tubular member for fixed anchoring at any one of a number of positions therealong a non threaded pipe can be readily adjusted in length to accommodate a particular wall thickness while readily accepting various types of standard fittings mounted thereon. Furthermore a clamping mechanism is provided which does not rely on threaded securement about the outer diameter of the pipe so that no awkward manipulation of a large fastening tool is required and so that installations with limited access can be more readily accommodated. The clamping mechanism serves to clamp the inner flange member tightly against the inner surface of the wall to ensure a stable mounting configuration of the inner flange member to prevent undesired leaking through the fitting assembly.

Preferably the retainer is arranged for non-threaded connection to the tubular member and is arranged to be clamped against diametrically opposed sides of the tubular member so as to be arranged to frictionally retain the tubular member therein. A portion of the retainer may be fixed to the anchor member for sliding movement together with the anchor member along the tubular member in a released position of the retainer.

The anchor member preferably comprises an annular body arranged to surround the tubular member in the form of a flat annular plate having a central aperture therein arranged to slidably receive the tubular member therethrough.

The clamping mechanism may comprise a plurality of threaded fasteners threadably secured to the annular body of the anchor member at circumferentially spaced positions about the tubular member. Preferably the threaded fasteners being arranged to protrude from an inner side of the annular body towards the outer surface of the pool wall by a protruding distance which is arranged to be adjustable by threaded rotation of the fasteners relative to the annular body.

The threaded fasteners are preferably mounted for threaded rotation about respective axes oriented parallel to the longitudinal direction. Preferably the clamping mechanism comprises four threaded fasteners arranged to protrude from the inner side of the annular by the adjustable protruding distance; however, any other number of fasteners at circumferentially spaced positions would be suitable.

When the assembly further comprises an outer flange member arranged to be supported on the tubular member between the anchor member and the outer surface of the pool wall for sliding movement relative to the tubular member in the longitudinal direction, the threaded fasteners of the clamping mechanism are preferably arranged to be operable between the anchor member and the outer flange member when the outer flange member is abutted against the outer surface of the pool wall.

When used in combination with a pool wall comprising a liner member spanning an inner surface of the pool wall, the assembly may further comprise a face flange member having a central portion arranged for mounting onto the central portion of the inner flange member and a flange portion spanning radially outward from the central portion so as to be arranged to clamp the liner member between the face flange member and the inner flange member. A pool inlet fitting or a pool drain fitting may be threadably secured to the face flange member.

When used in combination with a concrete pool wall having a liner member spanning the inner surface of the pool wall, the concrete wall is preferably clamped between the inner flange member and the clamping mechanism.

The opening through the concrete wall may be larger in diameter than the tubular member such that there is provided an annular space about the tubular member between the inner surface and the outer surface of the pool wall.

According to a second aspect of the present invention there is provided a fitting assembly in combination with a concrete pool wall comprising an inner surface, an outer surface and an opening extending through the wall from the inner surface to the outer surface of the pool wall, the fitting assembly comprising:

a tubular member extending in a longitudinal direction through the opening in the pool wall from an inner end adjacent the inner surface of the pool wall to an outer end at the outer surface of the pool wall;

an inner flange member comprising a central portion in threaded connection to the inner end of the tubular member and a flange portion extending radially outward from the central portion in overlapping configuration with the inner surface of the pool wall about a periphery of the opening;

an anchor member comprises an annular body supported about the tubular member between the pool wall and the outer end for sliding movement relative to the tubular member in the longitudinal direction;

a retainer fixed onto the tubular member adjacent the outer end of the anchor member so as to restrict movement of the anchor member in the longitudinal direction relative to the tubular member towards the outer end of the anchor member;

an outer flange member comprising a central portion supported about the tubular member between the anchor member and the outer surface of the pool wall so as to be arranged for sliding movement relative to the tubular member in the longitudinal direction and a flange portion extending radially outward from the central portion;

a clamping mechanism comprising a plurality of threaded fasteners threadably secured to the annular body of the anchor member at circumferentially spaced positions about the tubular member;

the threaded fasteners being arranged to protrude from an inner side of the annular body towards the outer surface of the pool wall by a protruding distance which is arranged to be adjustable by threaded rotation of the fasteners relative to the annular body such that the threaded fasteners are arranged to urge the anchor member together with the outer end of the tubular member relative to which the anchor member is retained by the retainer away from the outer surface of the pool wall such that the pool wall is clamped between the inner flange member and the outer flange member by the clamping mechanism.

According to a further aspect of the present invention there is provided a method of replacing an existing fitting assembly extending through a pool wall from an inner surface to an outer surface of the wall, the method comprising:

boring an opening through the wall from the inner surface to the outer surface of the wall about the existing fitting so as to remove the existing fitting from the pool wall;

inserting a tubular member through the opening so as to extend in a longitudinal direction from an inner end adjacent the inner surface of the pool wall to an outer end at the outer surface of the pool wall;

providing an inner flange member comprising a central portion and a flange portion extending radially outward from the central portion, the flange portion having a greater diameter than the opening through the wall;

threadably securing the central portion of the inner flange member to the inner end of the tubular member such that the flange portion overlaps the inner surface of the pool wall about a periphery of the opening;

supporting an anchor member about the tubular member for sliding movement relative to the tubular member in the longitudinal direction between the outer surface of the pool wall and the outer end of the tubular member;

fixing a retainer on the tubular member adjacent the outer end thereof such that the anchor member is prevented from movement in the longitudinal direction relative to the tubular member towards the outer end of the anchor member; and

mounting a clamping mechanism between the anchor member and the outer surface of the pool wall and operating the clamping mechanism so as to urge the anchor member together with the outer end of the tubular member away from the outer surface of the pool wall such that the pool wall is clamped between the inner flange member and the clamping mechanism.

The method may further comprise cutting a length of the tubular member according to a thickness of the pool wall.

Various embodiments of the invention will now be described in conjunction with the accompanying drawings in which:

### BRIEF DESCRIPTION OF THE DRAWINGS

FIG. 1 is an exploded perspective view of a first embodiment of the fitting assembly.

FIG. 2 is a partly sectional elevational view of the fitting assembly according to FIG. 1, shown extending through a pool wall.

FIG. 3 is an end view of the anchor member according to FIG. 1.

FIG. 4 is an end view of the outer flange member according to the first embodiment of FIG. 1.

FIG. 5 is and end view of the retainer according to FIG. 1.

FIG. 6 is a side elevational view of a second embodiment of the anchor member and retainer.

FIG. 7 is an end view of the anchor member and retainer according to FIG. 6.

In the drawings like characters of reference indicate corresponding parts in the different figures.

### DETAILED DESCRIPTION

Referring to the accompanying figures there is illustrated a pool wall fitting assembly generally indicated by reference numeral 10. The assembly 10 is particularly suited for use with a pool of the type comprising a concrete wall 12 having a lining material 14 spanning the inner surface of the wall. The fitting assembly 10 is typically mounted within an opening 16 comprising a bore extending through the wall from the inner surface to an opposing outer surface of the wall. While various embodiments are shown in the accompanying figures, the common features will first be described.

The fitting assembly 10 comprises a tubular member 18 comprising a section of pipe which is elongate in a longitudinal direction from an inner end 20 to an opposing outer end 22. The inner end 20 is externally threaded for threaded connection to an inner flange member 24 at the inner surface of the concrete wall. The length of the tubular member is selected to be greater than the thickness of the wall such that the outer end of the tubular member projects outwardly beyond the outer surface of the wall. Typically the outer end is cut to define the length of the tubular member corresponding to the thickness of the wall such that the outer end protrudes a sufficient distance beyond the outer surface of the wall to accommodate various anchoring components of the fitting assembly. The outer diameter of the tubular member is typically smaller in diameter than the bore or opening 16 extending through the wall such that there is an annular space defined about the tubular member 18 along the length thereof between the inner and outer surfaces of the wall.

The inner flange member mounted at the inner end of the tubular member for abutment against the inner surface of the pool wall comprises a central portion 26 in the form of a collar which is internally threaded for threaded connection onto the external threads of the inner end of the tubular member.

A flange portion 28 is formed integrally with the central portion in which the flange portion is flat and generally annular about the collar forming the central portion to span radially outward therefrom perpendicular to the longitudinal axis of the tubular member. The outer diameter of the flange portion is greater than the internal diameter of the opening 16 extending through the pool wall such that the flange portion 28 is arranged to overlap the inner surface of the pool wall about a full periphery of the opening.

The inner flange member 24 typically mounts a face flange 30 thereon in the form of an annular plate of smaller diameter than the flange portion for bolting against the outer face of the flange portion to accept suitable inlet or outlet fittings threaded thereon. A central opening in the face flange is internally threaded for receiving the various types of fittings therein.

An inlet fitting assembly 32 typically comprises a collar having suitable external threads for threading into the face flange 30 at an inner end and for threading a cap onto an outer end thereof in which the cap and the collar include mating recesses for receiving a suitable nozzle member clamp therebetween.

In alternative configurations, an outlet fitting 34 may be provided in the form of a drain cap which is internally threaded onto a suitable collar threadably received in the face flange 30.

To clamp the inner flange member 24 tightly against the inner surface of the pool wall, various components of the fitting assembly 10 are provided at the outer surface of the pool wall for operative connection to the outer end of the tubular member. More particularly the fitting assembly 10 further comprises an outer flange member 36 in the form of a flat annular plate having a central portion 38 locating a round aperture therein through which the tubular member is slidably received such that the outer flange member is slidable along the tubular member in the longitudinal direction thereof for engagement against the outer surface of the pool wall. The outer flange member 36 further comprises a flange portion 40 extending radially outward from the opening in the central portion 38 of the annular plate. The flange portion extends radially outward from the round aperture defining the central portion such that the flange portion is oriented generally perpendicular to the longitudinal direction of the tubular member and has an outer diameter which is greater than the opening through the pool wall for overlapping the outer surface of the wall above a full periphery of the openings.

The fitting assembly 10 further comprises an anchor member 42 which is arranged to be selectively anchored relative to the tube. The anchor member 42 also comprises a generally annular body in the form of a flat round plate having an aperture located centrally therein defining a central portion 44 of the anchor member.

The aperture in the central portion 44 slidably receives the tubular member therethrough such that the anchor member is slidable along the tubular member in the longitudinal direction thereof. The anchor member 42 is positioned closer to the outer end of the tubular member than the outer flange member 36 such that outer flange member 36 is received between the anchor member 42 and the outer surface of the pool wall.

In use the anchor member 42 is secured against sliding movement relative to the tubular member in an outward direction towards the outer end of the tubular member by a suitable retainer 46. The retainer 46 is arranged to be clamped about the tubular member adjacent the outer end thereof.

The retainer 46 is typically fixed onto the tubular member at a location spaced inwardly from the outer end thereof to provide suitable space for accommodating various pipe fittings to be mounted onto the outer end of the tubular member. The flange member 40 and the anchor member 42 are received between the retainer 46 fixed onto the tubular member and the outer surface of the pool wall to prevent longitudinal sliding movement of the anchor member away from the outer surface of the pool wall towards the outer end beyond the retainer 46.

A clamping mechanism is also provided in the form of a set of four threaded fasteners 54 which are mounted in the flange portion 56 of the annular body defining the anchor member 42. Similar to the flange member 36, the flange portion 56 of the anchor member spans radially outward from the central portion perpendicularly to the longitudinal direction such that the outer diameter is near to the outer diameter of the outer flange member 36.

The threaded fasteners 54 of the clamping mechanism are threaded through respective apertures in the flange portion of the anchor member at circumferentially spaced positions therein evenly about the tubular member in which each threaded fastener is supported for threaded rotation about a respective axis lying parallel to the longitudinal direction. Each of the fasteners 54 includes a bolt head formed at an outer end of the fastener for controlling the depth of the fasteners threaded into the anchor member in the longitudinal direction.

At the inner ends of the fasteners, opposite the heads thereof, each of the fasteners protrudes from the inner face of the anchor member towards the outer flange member 36 such that the free ends of the fasteners are arranged to engage the outer flange member at circumferentially spaced positions evenly above the flange portion 40 thereof. By threadably rotating the fasteners within the respective threaded apertures in the anchor member 42 the protruding distance of the fasteners from the anchor member 42 towards the outer flange member is adjustable. Increasing the length of protrusion of the fasteners from the inner surface of the anchor member towards the outer flange member thus causes the anchor member to be urged away from the outer surface of the wall.

Threaded nuts with split retainer rings are supported on each of the fasteners 54 adjacent the outer side of the anchor member 42 so that when tightened against the anchor member, the selected protruding distance of the fasteners from the inner side of the anchor member is fixed.

When the retainer is fixed directly adjacent the outer surface of the anchor member, urging the anchor member outwardly away from the wall thus in turn urges the retainer member outwardly from the wall along with the outer end of the tubular member onto which the retainer is fixed so that the outer end of the tubular member is pulled from the opening to effectively tightly engage the flange member against the inner surface of the pool wall. The clamping mechanism further urges the outer flange member 36 tightly against the outer surface of the wall at the same time and with an equal and opposite force to the inner flange member being clamped against the inner surface of the pool wall. The pool wall is thus effectively clamped between the inner and outer flanges of the fitting assembly with increasing clamping force as the threaded fasteners 54 of the clamping mechanism are tightened.

By providing a plurality of smaller threaded fasteners 54 at circumferentially spaced positions about the tubular member, the fasteners remain readily accessible for tightening even in installations with limited access at the outer surface of the pool wall.

When replacing an existing fitting cast into the concrete pool wall, a user typically bores a hole through the wall from the inner surface to the outer surface about the existing tubular member to form a new opening which is larger in diameter than the tubular member and associated fitting previously installed and cast into the pool wall. Suitable inner and outer flanges are selected which are greater in diameter than the new bore formed in the wall and a new pipe is installed having a smaller diameter than the new bore to define an annular space therebetween. Using the clamping mechanism of the fitting assembly 10 described herein, the inner and outer flanges can be tightly fastened against corresponding inner and outer surfaces of the wall and sealed in engagement therewith without the need for casting new concrete about the new pipe fitting to provide adequate support because the fitting assembly 10 already provides sufficient sealing support relative to the wall.

When using 1 ½ inch pipe, a common interior diameter of the outer flange member and the anchor member would be slightly greater at 2 inches while the retainer 46 when assembled has a diameter which is equal to or slightly less than the tubing to permit tight clamping about the tubing. An outer diameter of 5 ¾ inches for the flanges is typically sufficient.

When larger 2 inch pipe is used, the outer diameter may remain the same, however the inner diameter of the openings in the outer flange member and the anchor member may be increased to 2 ½ inches and the inner diameter of the retainer 46 increased to 2 inches.

If larger 3 inch pipe is used, the inner diameter of the openings in the anchor member and outer flange member may be increased to 3 ⅝ inches while the outer diameters of the flange portions may be increased to 6 ¾ inches. The retainer would also be increased to have an approximately 3 inch internal diameter.

Typically the components are all formed of metal, for example galvanized steel. Zinc plating may be provided on some components, for example the retainer 46.

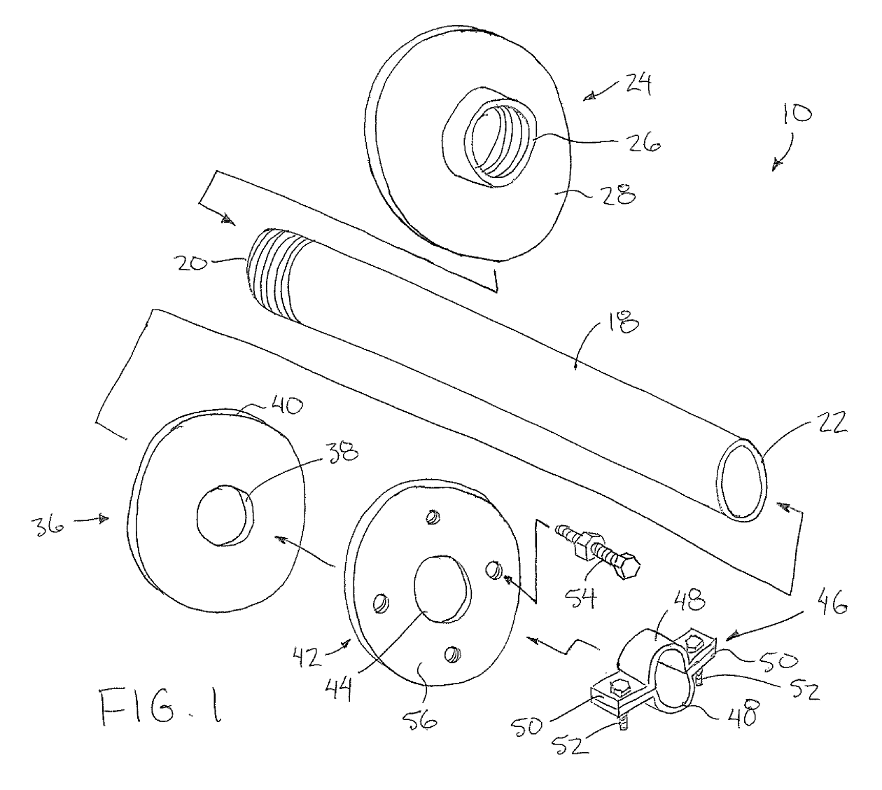

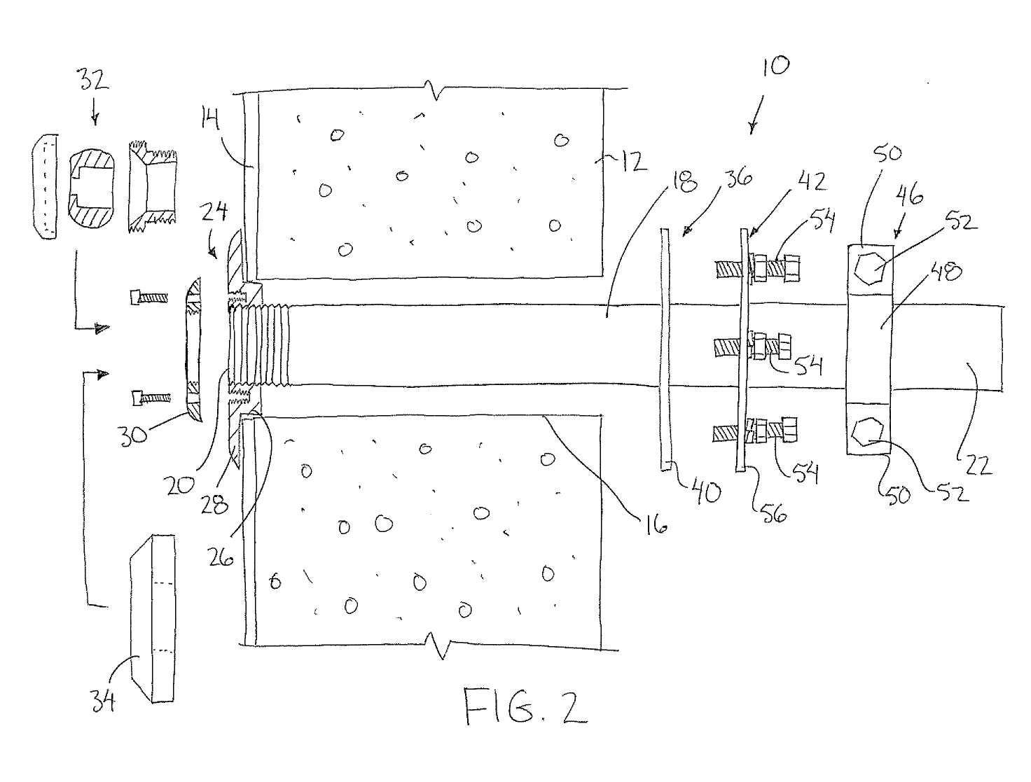

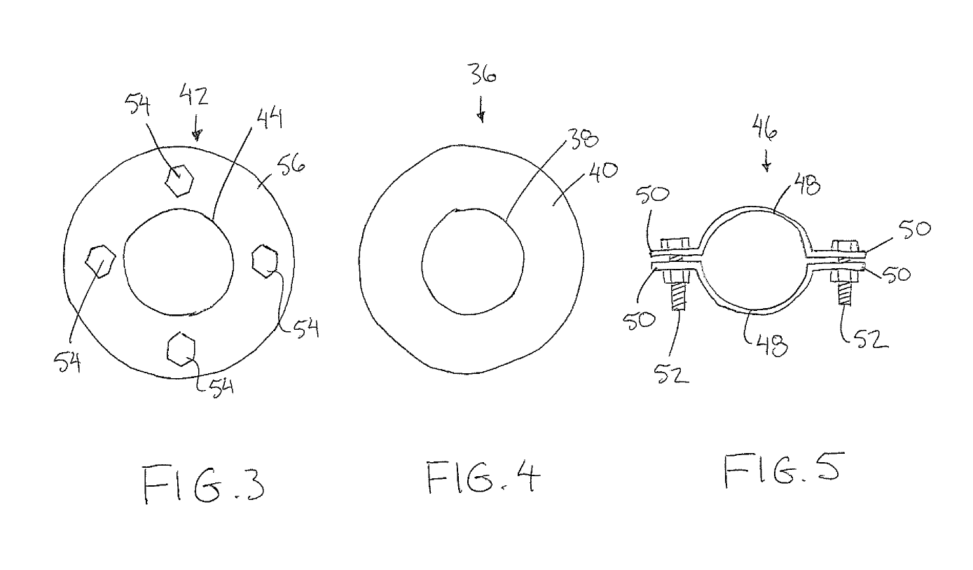

Turning now to the embodiment of FIGS. 1 through 5, the retainer 46 more particularly comprises first and second clamping portions 48 in which each of the clamping portions comprises a generally U-shaped central portion arranged to receive approximately half of a cross sectional area of the tubular member therein. Accordingly when the 2 clamping portions are engaged on diametrically opposed sides of the tubular member, the clamping portions are arranged to substantially fully surround the tubular member.

Each of the U-shaped clamping portions comprises a pair of end flanges 50 extending generally radially outward from the tubular member at opposing ends. Suitable apertures within the end flanges 50 are arranged to receive suitable threaded fasteners 52 therethrough to effectively clamp the first and second clamping portions together at diametrically opposed positions. When clamped together, the first and second clamping portions are arranged to be frictionally retained at a fixed position along the tubular member.

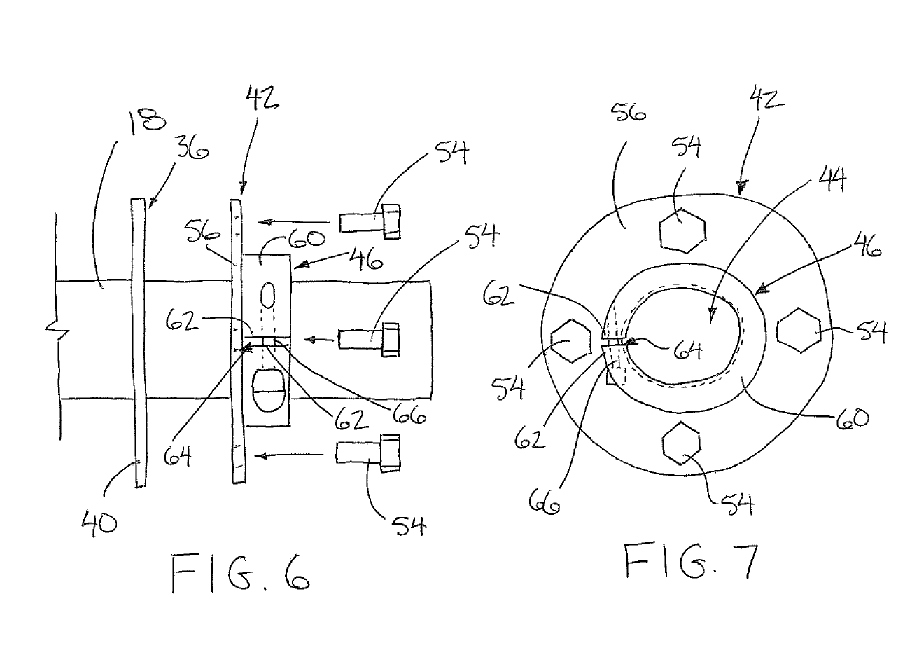

Turning now to the embodiment of FIGS. 6 and 7, the retainer 46 in this instance is shown supported together with the anchor member 42. The anchor member in this instance again comprises a flat circular plate defining an annular flange portion 56 which extends radially outward from a central opening 38 through which the tubular member 18 is arranged to be slidably received. The central opening 38 is near in dimension to the outer diameter of the tubular member such that the anchor member 42 is again well suited to be supported to span perpendicularly to the longitudinal direction of the tubular member while being slidable along the tubular member in the longitudinal direction thereof.

The retainer 46 in this embodiment differs from the previous embodiment in that the retainer generally comprises a single clamp member 60 which is generally C-shaped to extend circumferentially about a central circular opening receiving the tubular member 18 therethrough. The clamp member 60 extends circumferentially between two opposed ends 62 which are positioned in close proximity to one another so that the clamp member extends substantially fully about the circumference of the tubular member.

In a released position, the two ends 62 remain spaced apart by a gap 64 therebetween in the circumferential direction such that the internal diameter of the central opening of the clamp member is slightly greater than the outer diameter of the tubular member. The retainer 46 thus remains slidable along the tubular member in the longitudinal direction while the retainer remains in a released position.

A portion of the circumference of the clamp member is fixed to the outer side of the anchor member such that the retainer 46 remains fixed to the anchor member 42 for sliding movement together therewith along the tubular member. A diametrically opposed portion of the clamp member 60 remains unattached to the anchor member to permit flexing of the clamp member from the released position to a clamped position in which the two ends 62 are brought closer together to reduce the internal diameter of the central opening sufficiently to clamp about the exterior of the tubular member. Accordingly, in the clamped position, the retainer is arranged to be frictionally fixed in position relative to the tubular member which in turn fixes the position of the anchor member relative to the tubular member.

The clamp member 60 is displaced from the released position to the clamped position by a suitable threaded fastener 66 coupled between the two ends 62 of the clamp member. The fastener 66 includes a head which is rotatably retained on a suitable shoulder formed on one of the two ends 62 while the other end of the fastener is threaded into the other one of the two ends 62 of the clamp member. Accordingly, rotating the fastener 66 serves to clamp the two ends 62 together and frictionally retain the retainer onto the tubular member in the clamped position.

In use, the tubular member 18 is first extended through the opening in the wall as described above with the inner flange member 24 being threadably secured to the inner end at the inner surface of the wall. The retainer 46 and anchor member 42 are then slidably mounted together onto the outer end of the tubular member 18 until the fasteners 54 of the clamping mechanism which are threaded into the flange portion of the anchor member 42 again abut the outer flange member 36 which is in turn abutted with the outer surface of the pool wall. Once the retainer is fixed relative to the tubular member in the clamped position, adjustment of the fasteners 54 of the clamping mechanism urges the outer end of the tubular member away from the pool wall to effectively clamp the pool wall between the inner flange member and the outer flange member as described above.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of replacing an existing fitting assembly extending through a pool wall from an inner surface to an outer surface of the wall, the method comprising:
boring an opening through the wall from the inner surface to the outer surface of the wall about the existing fitting so as to remove the existing fitting from the pool wall;
inserting a tubular member through the opening so as to extend in a longitudinal direction from an inner end adjacent the inner surface of the pool wall to an outer end at the outer surface of the pool wall;
providing an inner flange member comprising a central portion and a flange portion extending radially outward from the central portion, the flange portion having a greater diameter than the opening through the wall;
threadably securing the central portion of the inner flange member to the inner end of the tubular member such that the flange portion overlaps the inner surface of the pool wall about a periphery of the opening;
supporting an anchor member about the tubular member for sliding movement relative to the tubular member in the longitudinal direction between the outer surface of the pool wall and the outer end of the tubular member;
fixing a retainer on the tubular member adjacent the outer end thereof such that the anchor member is prevented from movement in the longitudinal direction relative to the tubular member towards the outer end of the anchor member; and
mounting a clamping mechanism between the anchor member and the outer surface of the pool wall and operating the clamping mechanism so as to urge the anchor member together with the outer end of the tubular member away from the outer surface of the pool wall such that the pool wall is clamped between the inner flange member and the clamping mechanism.

2. The method according to claim 1 including cutting a length of the tubular member according to a thickness of the pool wall such that the tubular member protrudes from the outer surface of the pool wall.

3. The method according to claim 1 including boring the opening in the pool wall to be larger in diameter than the tubular member such that there is provided an annular space about the tubular member between the inner surface and the outer surface of the pool wall.

4. The method according to claim 1 for use with a pool wall comprising a liner member spanning an inner surface of the pool wall, wherein the method further comprises clamping the flange portion of the inner flange member against the liner member.

5. The method according to claim 1 including securing a face flange member to the inner flange member and threadably securing a pool inlet fitting to the face flange member.

6. The method according to claim 1 including securing a face flange member to the inner flange member and threadably securing a pool drain fitting to the face flange member.

7. The method according to claim 1 for use with a concrete pool wall, wherein the method includes clamping the concrete pool wall between the inner flange member and the clamping mechanism.

8. The method according to claim 1 including an outer flange member having a central portion arranged to be supported on the tubular member between the anchor member and the outer surface of the pool wall for sliding movement relative to the tubular member in the longitudinal direction and a flange portion extending radially outward from the central portion such that the clamping mechanism is arranged to be operable between the anchor member and the outer flange member when the outer flange member is abutted against the outer surface of the pool wall.

9. The method according to claim 1 including securing the retainer non-threadably to the tubular member.

10. The method according to claim 1 including clamping the retainer against diametrically opposed sides of the tubular member so as to be arranged to frictionally retain the tubular member therein.

11. The method according to claim 1 including fixing at least a portion of the retainer to the anchor member for sliding movement together with the anchor member along the tubular member in a released position of the retainer.

12. The method according to claim 1 wherein the anchor member comprises an annular body and the method includes surrounding the tubular member with the annular body.

13. The method according to claim 12 wherein the anchor member comprises a flat annular plate having a central aperture and the method includes slidably receiving the tubular member through the central aperture.

14. The method according to claim 12 wherein the clamping mechanism comprises a plurality of threaded fasteners threadably secured to the annular body of the anchor member at circumferentially spaced positions about the tubular member, and the method includes mounting the threaded fasteners to protrude from an inner side of the annular body towards the outer surface of the pool wall by a protruding distance which is arranged to be adjustable by threaded rotation of the fasteners relative to the annular body.

15. The method according to claim 14 including mounting the threaded fasteners for threaded rotation about respective axes oriented parallel to the longitudinal direction.

16. The method according to claim 14 including providing an outer flange member arranged to be supported on the tubular member between the anchor member and the outer surface of the pool wall for sliding movement relative to the tubular member in the longitudinal direction, and mounting the threaded fasteners of the clamping mechanism being so as to be operable between the anchor member and the outer flange member when the outer flange member is abutted against the outer surface of the pool wall.
